(19) United States
(12) Patent Application Publication
(10) Pub. No.: US 2018/0231511 A1
(43) Pub. Date: Aug. 16, 2018

(54) DETECTOR FOR LIQUID CHROMATOGRAPHY

(71) Applicant: Shimadzu Corporation, Kyoto (JP)

(72) Inventor: Hiroshi TANAKA, Kyoto-city (JP)

(73) Assignee: Shimadzu Corporation, Kyoto (JP)

(21) Appl. No.: 15/752,977

(22) PCT Filed: Aug. 18, 2015
(86) PCT No.: PCT/JP2015/073152

§ 371 Date: Feb. 15, 2018

(51) Int. Cl. G01N 30/74; G01N 30/78

(52) U.S. Cl. CPC G01N 30/74; G01N 2030/027; G01N 30/78

(57) ABSTRACT

Provided is a liquid chromatographic detector in which two detectors of a differential refractive index detector and an absorbance detector are used, the liquid chromatographic detector being configured to prevent, as much as possible, any difference from being generated in the detection results of both detectors. By using a liquid chromatographic detector including a differential refractive index detector housed in a housing; an absorbance detector housed in the housing; and the connection pipe that is a flow path connecting between the differential refractive index detector and the absorbance detector which are housed in the housing, the length of the connection pipe can be shortened and diffusion of target components can be minimized.

### TECHNICAL FIELD

The present invention relates to a liquid chromatographic detector including a differential refractive index detector and an absorbance detector.

### BACKGROUND ART

A liquid chromatograph quantitatively and qualitatively analyzes one or plural components in a liquid sample by temporally separating the components contained in the liquid sample with a column and detecting the separated components with a detector at a later stage.

In a case where a liquid chromatograph is used to measure a polymer component in a liquid sample, a differential refractive index detector is used because changes in the refractive index of the target components are large. In addition, in a case where the liquid sample further contains a small amount of an additive such as a plasticizer, an absorbance detector having higher sensitivity than the differential refractive index detector is used in combination with the differential refractive index detector for analyzing the additive (see, for example, PTL 1).

PTL 1 describes a liquid chromatograph in which a differential refractive index detector and an absorbance detector are connected to each other in series. In this liquid chromatograph, a liquid sample is separated by a column into a polymer component and a low molecular component such as an additive, and these separated components are sequentially introduced into the differential refractive index detector and the absorbance detector, thereby causing the respective detectors to create chromatograms for the polymer component and the additive, respectively.

Further, in a case where the additive can be detected even with a differential refractive index detector but with low sensitivity, it is possible to verify the validity of the data of both detectors by comparing this chromatogram with the chromatogram of the absorbance detector. Besides, the chromatograms of a sample that can be detected by both detectors of the differential refractive index detector and the absorbance detector can be used for checking the purity of chromato peaks, for searching for failure of the detectors, and the like.

### CITATION LIST

### Patent Literature

[PTL 1] JP-A-05-307001
Non Patent Literature

[NPL 1] Matsushita Itaru “Liquid Chromatography-Q&A 100”, published by Gihodo Shuppan Co., Ltd., June 2000, ISBN 4-7655-0387-9, p. 229

### SUMMARY OF INVENTION

### Technical Problem

In a case where two detectors are connected to each other in series, target components having passed through a first detector diffuse in a mobile phase until the target components flow through a pipe and reach a second detector (see NPL 1). Thus, there is a problem that the chromatogram of the detector at a later stage has a broader peak than that of the detector at a preceding stage, thereby generating a difference in the results of comparison between the two chromatograms.

Further, both the differential refractive index detector and the absorbance detector are easily affected by the temperature of the sample. Therefore, in a case where the temperature of the sample changes while flowing through the pipe connecting the two detectors, there is a problem that a difference is generated in the results of comparison between the chromatograms at the two detectors.

An object of the invention is to provide a liquid chromatographic detector in which in a case where two detectors of a differential refractive index detector and an absorbance detector are used, any difference is not generated in the detection results of both detectors, as much as possible.

### Solution to Problem

To attain the above object, there is provided a liquid chromatographic detector according to the invention, including:

a) an absorbance detector housed in a housing,

b) a differential refractive index detector housed in the housing, and

c) a connection pipe that is a flow path connecting between the absorbance detector and the differential refractive index detector which are housed in the housing.

In a liquid chromatograph of the related art, the differential refractive index detector and the absorbance detector are housed in separate housings, respectively, and a pipe is provided so as to connect these housings to each other. Thus, depending on the disposition of both housings, the length of the pipe that connects them to each other becomes long, and the diffusion of the components in the pipe becomes large. In contrast, in a liquid chromatograph according to the invention, the differential refractive index detector and the absorbance detector are housed in the same housing. Thus, the length of the connection pipe can be generally made shorter than that of a pipe of the related art. As a result, diffusion of the target components is suppressed compared to that in the liquid chromatograph of the related art, thereby allowing each detector to perform measurement in substantially the same state in each detector. Furthermore, it is possible to eliminate the influence of the temperature change caused by the pipe running along the outside of the housing.

A light emitting diode (LED) can be suitably used as the light source of the absorbance detector.

In the liquid chromatograph of the related art, a white light source such as a deuterium lamp is used in the absorbance detector. Thus, it is necessary to use a spectroscopic unit that has a diffraction grating for extracting desired light and a motor for driving the diffraction grating, and it is difficult to house the absorbance detector and the differential refractive index detector in the same housing. On the other hand, in a case where an LED light source having a narrow range of emission wavelength is used, the spectroscopic unit becomes unnecessary. Therefore, it is possible to miniaturize the absorbance detector so as to be housed in the housing.

It is preferable that the liquid chromatographic detector includes temperature adjustment means for adjusting a temperature inside the housing.

Both the differential refractive index detector and the absorbance detector are easily affected by the temperature of the sample and the temperature of the environment surrounding the detectors. By adjusting the temperature inside the housing by the temperature adjustment means, the temperature of the environment surrounding each detector, and the temperature of the sample and the connection pipe can be kept constant, thereby stabilizing the measurement accuracy. As the temperature adjustment means, a heater for heating the inside of the housing or a Peltier element for heating and cooling can be used.

In the liquid chromatographic detector, it is preferable that the absorbance detector is disposed upstream of the differential refractive index detector.

Usually, the volume of the cell used for the differential refractive index detector is larger than the volume of the cell for the absorbance detector. Thus, in a case where the differential refractive index detector is disposed on the upstream side, the target components diffuse when passing through the cell for the differential refractive index detector, and in a subsequent measurement in the absorbance detector, the measurement is performed for the sample with a large amount of diffusion, which is not preferable. In contrast, in a configuration in which the absorbance detector is disposed upstream, since the volume of the cell for the absorbance detector is small, measurement can be performed in a state in which an amount of diffusion in the target components in the cell is small.

### Advantageous Effects of Invention

By using the liquid chromatographic detector according to the invention, it is possible to shorten the length of the connection pipe between the two detectors of the differential refractive index detector and the absorbance detector, and to minimize the diffusion of the target components. In addition, the two detectors and the connection pipe are housed in the same housing, and thus the influence of the temperature change in a sample outside the housing is eliminated. Therefore, a difference between the detection results of the two detectors can be reduced.

### BRIEF DESCRIPTION OF DRAWINGS

FIG. 1 is a schematic configuration diagram of a liquid chromatograph according to an embodiment of the invention.

FIG. 2 is an example of a chromatogram measured by the liquid chromatograph according to the invention. (a) of FIG. 2 shows absorbance characteristics of a sample in which the components are separated; (b) of FIG. 2 shows differential refractive index characteristics of the sample in which the components are separated; (c) of FIG. 2 shows a signal intensity ratio of (a) and (b) of FIG. 2; (d) of FIG. 2 shows the absorbance characteristics of a sample in which the components are not separated; (e) of FIG. 2 shows the differential refractive index characteristics of the sample in which the components are not separated; and (f) of FIG. 2 shows the signal intensity ratio of (d) and (e) of FIG. 2.

### DESCRIPTION OF EMBODIMENTS

Hereinafter, embodiments for carrying out the invention will be described with reference to the drawings.

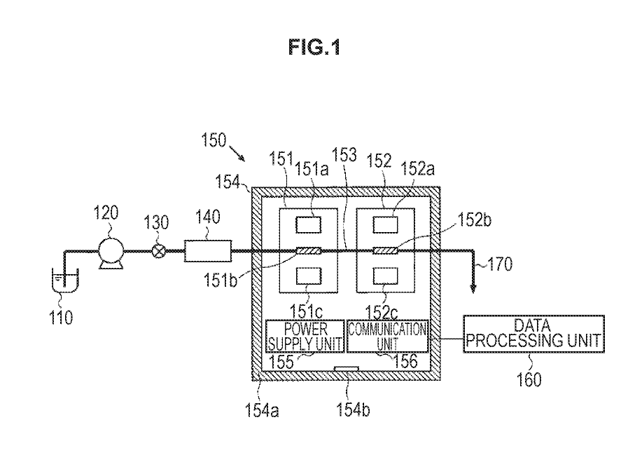

FIG. 1 is a schematic configuration diagram of a liquid chromatograph according to an embodiment of the invention. This liquid chromatograph is configured to include a mobile phase vessel 110 storing a mobile phase, a liquid feed pump 120, an injector 130 for injecting a sample into the mobile phase, a column 140, a liquid chromatographic detector 150, a data processing device 160, and a waste liquid flow path 170.

A column for gel permeation chromatography (GPC) is used for the column 140. In the column for GPC, the target components in the sample are temporally separated and eluted depending on the size of the molecular weight. The type of column to be used is not limited to the one for GPC, and can be appropriately selected depending on the type of sample to be analyzed.

The liquid chromatographic detector 150 is configured to include, in a housing 154, an ultraviolet absorbance detector 151, a differential refractive index detector 152, a connection pipe 153 connecting between these two detectors, a power supply unit 155, and a communication unit 156 for communicating with the data processing device 160.

The ultraviolet absorbance detector 151 includes an absorbance meter flow cell 151b connected (via a flow path) to the outlet of the column 140, an ultraviolet LED light source 151a for irradiating the flow cell 151b with ultraviolet light, and an ultraviolet light detection element 151c for detecting the ultraviolet light having passed through the absorbance meter flow cell 151b.

The differential refractive index detector 152 includes a differential refractive index flow cell 152b connected via a connection pipe 153 to the absorbance meter flow cell 151b, a differential refractive index light source 152a for irradiating the flow cell 152b with light, and a differential refractive index detection element 152c for detecting the light having passed through the differential refractive index flow cell 152b. The differential refractive index flow cell 152b is provided with a sample cell through which the sample from the column 140 flows and a control cell through which a control sample (mobile phase) flows. When passing through the differential refractive index flow cell 152b, the light emitted from the differential refractive index light source 152a has a deviation on its optical path which results from the difference in refractive index between the sample flowing in the sample cell and the mobile phase flowing in the control cell. Thus, the amount of deviation is obtained from the detection results of the differential refractive index detection element 152c, and the component concentration in the sample is calculated from the amount of deviation.

The housing 154 is provided with a heat insulation material 154a in the inside thereof, and thus is configured such that a temperature change outside the housing 154 is hardly transferred to the inside of the housing 154. In addition, a heater 154b is provided inside the heat insulation material 154a, and is controlled by a control unit (not shown) such that the temperature inside the housing 154 is kept constant.

The power supply unit 155 is connected (not shown) to the respective units such as the ultraviolet absorbance detector 151, the differential refractive index detector 152, and the heater 154b in the liquid chromatographic detector 150, and supplies electric power to each device. The communication unit 156 is connected (not shown) to the ultraviolet absorbance detector 151, the differential refractive index detector 152, and the data processing device 160, and relays the data which is transmitted and received between the data processing device 160 and each device in the housing 154.

The data processing device 160 is connected to the communication unit 156 and performs transmission of the control signal to the ultraviolet absorbance detector 151 and the differential refractive index detector 152 via the communication unit 156 and reception of the detection signal from these detectors. In addition, a chromatogram is created based on the data sent from each detector.

An analysis procedure of a sample using a liquid chromatograph according to the present embodiment will be described with reference to FIG. 1. In this case, a sample containing a polymer component and a low molecular component such as an additive is analyzed.

The liquid feed pump 120 feeds the mobile phase in the mobile phase vessel 110 toward the column 140. The injector 130 injects the sample into this mobile phase. The mobile phase containing the sample is temporally separated into a polymer component and a low molecular component such as an additive depending on the molecular weight in the column 140.

The separated sample flows into the flow cell 151b of the ultraviolet absorbance detector 151. The ultraviolet light emitted from the ultraviolet LED light source 151a is absorbed depending on the sample flowing through the absorbance meter flow cell 151b and the ultraviolet light having passed through the flow cell 151b is detected by the ultraviolet light detection element 151c. This detection result is sent to the data processing device 160 via the communication unit 156, and a chromatogram is created based on the detection result.

The sample having passed through the ultraviolet absorbance detector 151 flows into the flow cell 152b of the differential refractive index detector 152 via the connection pipe 153. When passing through the flow cell 152b, a differential refractive index is measured by the differential refractive index light source 152a and the differential refractive index detection element 152c. This measurement result is sent to the data processing device 160 via the communication unit 156, and a chromatogram is created based on this measurement result.

The sample for which the measurement has been completed by each detector is discarded via the waste liquid flow path 170.

In the liquid chromatographic detector 150 according to the invention, since the ultraviolet absorbance detector 151 and the differential refractive index detector 152 are housed in the same housing 154, the connection pipe 153 can be generally shortened. In addition, in the technology of the related art, since the housing, the heat insulation material, and the heater are provided for each of the ultraviolet absorbance detector and the differential refractive index detector, the size of the entire liquid chromatograph is increased. In the liquid chromatographic detector 150 according to the invention, since the housing 154, the heat insulation material 154a, and the heater 154b are shared by the two detectors, the connection pipe 153 can be shortened and the entire liquid chromatograph can be miniaturized. In addition, since the power supply unit 155 and the communication unit 156 can also be shared, further miniaturization can be achieved.

In addition, since the two detectors share a configuration for holding or adjusting the temperature such as the heat insulation material 154a and the heater 154b, it is possible to allow the temperature of the environment surrounding the two detectors to become uniform as well as to allow the temperature of the sample to be kept constant.

Hereinafter, data obtained by using the liquid chromatographic detector according to the invention will be described.

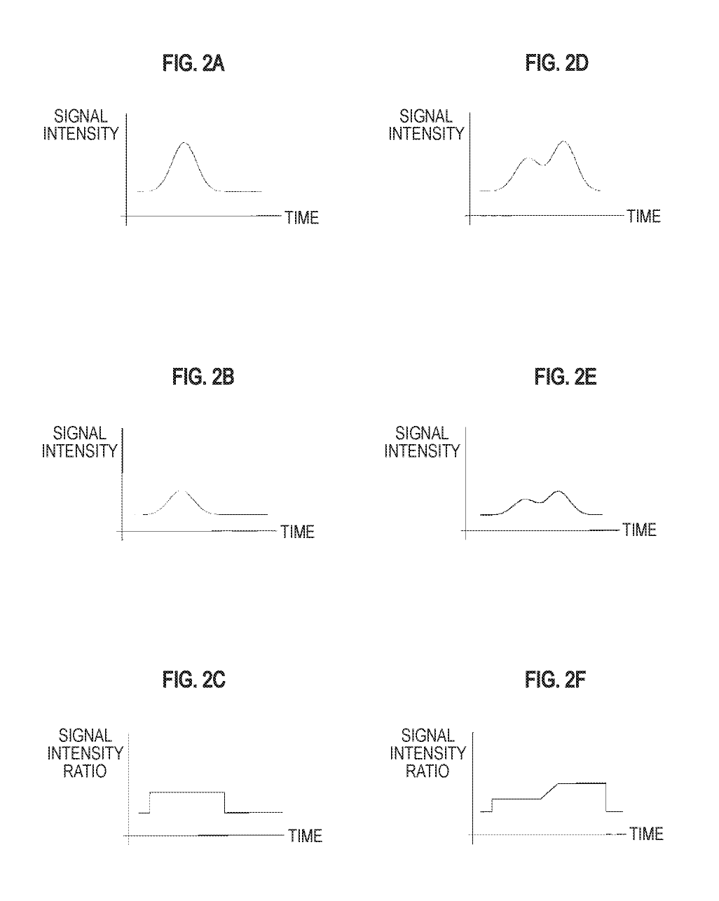

By calculating the output ratio of the ultraviolet absorbance detector and the differential refractive index detector, it is possible to check the purity of the peak in the chromatogram as described below. In a case where the peak of the chromatogram is completely separated, the ultraviolet absorbance and the refractive index are proportional to the concentration of the component measured. Therefore, from the measurement results of the absorbance detector and the differential refractive index detector, chromatogram peaks that are substantially similar are obtained as shown in (a) and (b) of FIG. 2, respectively. The signal intensity ratio thereof is constant near the peaks as shown in (c) of FIG. 2. On the other hand, in a case where the peaks are not separated, the ultraviolet absorbance and the refractive index is such that a difference is generated in changes in the absorbance and the refractive index per concentration depending on the components to be detected, and thus chromatograms having different shapes are obtained as shown in (d) and (e) of FIG. 2. The signal intensity ratio thereof is not constant as shown in (f) of FIG. 2. In this way, by calculating the signal intensity ratio of the two detectors with different detection methods, the purity of chromato peaks can be checked. In the technology of the related art, since the sample easily diffuses, it is difficult to determine the separation of the peaks. However, in the liquid chromatograph according to the invention, since measurement can be performed in a state where the amount of diffusion and the temperature of the sample are substantially the same, it is possible to make an accurate determination.

The ultraviolet absorbance detector has a shorter time from activation of the detector to achievement of a stable baseline than the differential refractive index detector. Therefore, by using the ultraviolet absorbance detector when checking the performance (injection reproducibility or the like) of the chromatographic part in the inspection or the like of the liquid chromatograph, it is possible to shorten the time required for checking the performance of the chromatographic part compared to the liquid chromatograph having only the differential refractive index detector.

The liquid chromatographic detector according to the invention can be used for investigating the cause of trouble in the liquid chromatograph. By injecting a sample, which can be detected by both the ultraviolet absorbance detector and the differential refractive index detector and the measurement results of which are known, into the liquid chromatograph, and then performing measurement to compare the measurement results of the two detectors, the following information can be obtained. For example, in a case where noise is generated in the signals of both detectors, it is found that such a noise indicates not a noise derived from the detectors but there is a high possibility that some components in the sample are eluted. In addition, in a case where noise is generated only in the signal of one detector, it is found that there is a possibility of failure of the detector or the like.

The above embodiment is merely an example and can be appropriately modified within the scope and spirit of the invention. For example, the above embodiment describes a configuration in which a polymer sample is analyzed. However, any sample other than the polymer sample can be analyzed as long as the sample contains a component that can be detected by either the differential refractive index detector or the ultraviolet absorbance detector.

Further, although an LED that emits ultraviolet light is used as the light source of the absorbance detector, a mercury lamp that has a narrow spectrum similar to the LED may be used. In addition, besides ultraviolet light, a light source such as visible light or infrared light and a detector can be used. A white light source may be used as in the case of the related art. In that case, only the flow cell is housed in the same housing as the differential refractive index detector, and a spectroscopic unit for extracting monochromatic light from the white light emitted from the white light source is disposed at any position either inside or outside the housing. Then, the monochromatic light extracted in the spectroscopic unit may be transported by an optical fiber and irradiated to the absorbance detector flow cell.

Further, in the above embodiment, the absorbance detector and the differential refractive index detector are disposed in this order, but the differential refractive index detector may be disposed on the upstream side.

### REFERENCE SIGNS LIST

110: Mobile phase vessel
120: Liquid feed pump
130: Injector
140: Column
150: Liquid chromatographic detector
151: Ultraviolet absorbance detector
151a: Ultraviolet LED light source
151b: Absorbance meter flow cell
151c: Ultraviolet light detection element
152: Differential refractive index detector
152a: Differential refractive index light source
152b: Differential refractive index flow cell
152c: Differential refractive index detection element
153: Connection pipe
154: Housing
154a: Heat insulation material
154b: Heater
155: Power supply unit
156: Communication unit
160: Data processing device
170: Waste liquid flow path

1-4. (canceled)

5. A liquid chromatographic detector comprising:
a) an absorbance detector housed in a housing;
b) a differential refractive index detector housed in the housing; and
c) a connection pipe that is a flow path connecting the absorbance detector and the differential refractive index detector to each other which are housed in the housing,
wherein the housing has one or plural internal spaces, and the absorbance detector, the differential refractive index detector, and the connection pipe are disposed in a common internal space.

6. The liquid chromatographic detector according to claim 5,
wherein a light source used for the absorbance detector is an LED, and
the LED is disposed in the common internal space along with the absorbance detector, the differential refractive index detector, and the connection pipe.

7. The liquid chromatographic detector according to claim 5,
wherein the absorbance detector is disposed upstream of the differential refractive index detector.

8. The liquid chromatographic detector according to claim 5, further comprising:
temperature adjustment means for adjusting a temperature of the common internal space of the housing.

9. The liquid chromatographic detector according to claim 8, wherein the temperature adjustment means is provided in common to the absorbance detector and the differential refractive index detector, and
the temperature around the absorbance detector and the temperature around the differential refractive index detector are adjusted so as to be equal to each other.

10. The liquid chromatographic detector according to claim 5, wherein the housing includes a heat insulation material provided in a range including at least the absorbance detector and the differential refractive index detector in the common internal space.

11. The liquid chromatographic detector according to claim 6, wherein the absorbance detector is disposed upstream of the differential refractive index detector.

12. The liquid chromatographic detector according to claim 6, further comprising:
temperature adjustment means for adjusting a temperature of the common internal space of the housing.

13. The liquid chromatographic detector according to claim 12, wherein the temperature adjustment means is provided in common to the absorbance detector and the differential refractive index detector, and
the temperature around the absorbance detector and the temperature around the differential refractive index detector are adjusted so as to be equal to each other.

14. The liquid chromatographic detector according to claim 7, further comprising:
temperature adjustment means for adjusting a temperature of the common internal space of the housing.

15. The liquid chromatographic detector according to claim 14, wherein the temperature adjustment means is provided in common to the absorbance detector and the differential refractive index detector, and
the temperature around the absorbance detector and the temperature around the differential refractive index detector are adjusted so as to be equal to each other.

16. The liquid chromatographic detector according to claim 11, further comprising:
temperature adjustment means for adjusting a temperature of the common internal space of the housing.

17. The liquid chromatographic detector according to claim 16, wherein the temperature adjustment means is provided in common to the absorbance detector and the differential refractive index detector, and
the temperature around the absorbance detector and the temperature around the differential refractive index detector are adjusted so as to be equal to each other.

18. The liquid chromatographic detector according to claim 6, wherein the housing includes a heat insulation material provided in a range including at least the absorbance detector and the differential refractive index detector in the common internal space.

19. The liquid chromatographic detector according to claim 7, wherein the housing includes a heat insulation material provided in a range including at least the absorbance detector and the differential refractive index detector in the common internal space.

20. The liquid chromatographic detector according to claim 8, wherein the housing includes a heat insulation material provided in a range including at least the absorbance detector and the differential refractive index detector in the common internal space.

21. The liquid chromatographic detector according to claim 9, wherein the housing includes a heat insulation material provided in a range including at least the absorbance detector and the differential refractive index detector in the common internal space.

22. The liquid chromatographic detector according to claim 11, wherein the housing includes a heat insulation material provided in a range including at least the absorbance detector and the differential refractive index detector in the common internal space.

23. The liquid chromatographic detector according to claim 12, wherein the housing includes a heat insulation material provided in a range including at least the absorbance detector and the differential refractive index detector in the common internal space.

24. The liquid chromatographic detector according to claim 14, wherein the housing includes a heat insulation material provided in a range including at least the absorbance detector and the differential refractive index detector in the common internal space.
